(19) United States
(12) Patent Application Publication
(10) Pub. No.: US 2007/0236125 A1
(43) Pub. Date: Oct. 11, 2007

(54) SPARK PLUG

(75) Inventors: James D. Lykowski, Temperance, MI (US); Iryna Levina, Minneapolis, MN (US)

Correspondence Address: DICKINSON WRIGHT PLLC, 38525 WOODWARD AVENUE, SUITE 2000, BLOOMFIELD HILLS, MI, 48304-2970, US

(73) Assignee: Federal-Mogul World Wide, Inc., Southfield, MI (US)

(21) Appl. No.: 11/697,559

(22) Filed: Apr. 6, 2007

Related U.S. Application Data
(60) Provisional application No. 60/790,216, filed on Apr. 7, 2006.

(51) Int. Cl. H01T 13/20

(52) U.S. Cl. 313/141

(57) ABSTRACT

A spark plug having a center electrode with a spark portion formed from a sintered powdered metal and a method of manufacture thereof.

### CROSS-REFERENCE TO RELATED APPLICATIONS

This application claims priority to U.S. Provisional Application Ser. No. 60/790,216, filed Apr. 7, 2006 which is incorporated herein by reference.

### BACKGROUND OF THE INVENTION

1. Technical Field

This invention is directed to spark plugs and other ignition devices used in internal combustion engines and, more particularly, to ignition devices having a high performance center electrode or a high performance firing tip attached to a center electrode.

2. Related Art

Spark plugs are well known in the industry and have long been used to initiate combustion in internal combustion engines. In general, a spark plug is a device that extends into a combustion chamber of an internal combustion engine and enables a spark to ignite a combustible mixture of air and fuel therein. A spark plug typically includes a cylindrical metal shell having external threads that engage a threaded portion of the engine and a hook shaped ground electrode attached thereto at a firing end of the spark plug. A cylindrical insulator is disposed partially within the metal shell and extends axially beyond the metal shell toward a firing end and also toward a terminal end. A conductive terminal is disposed within the cylindrical insulator at the terminal end of the spark plug, opposite the firing end. At the firing end, a center electrode is disposed within the insulator and projects axially out of the insulator toward the ground electrode, whereby a spark plug gap is defined between the center electrode and the ground electrode.

Spark plugs perform the basic function of igniting gases in an engine cylinder, the ignition of which creates the power stroke. More specifically, the spark ignites the air and fuel mixture within the combustion chamber or cylinder to create high temperature combustion to power the engine. Due to the very nature of an internal combustion engine, spark plugs are exposed to many extremes occurring within the engine cylinder, including high temperatures and various corrosive combustion gases, which have traditionally reduced the longevity of the spark plug. Spark plugs also experience electrical spark erosion which reduces the longevity of spark plugs. Electrical spark erosion occurs when the electrode and in particular the firing tip or a material next to or adjacent to the firing tip erodes away during operation due to localized vaporization resulting from high arc temperatures of the electrical arc during operation of the spark plug. The longevity of spark plugs is generally reduced due to the center electrode and the ground electrode becoming degraded, thereby degrading the quality of the spark between the center electrode and ground electrode. If the quality of the spark becomes degraded, the resulting ignition and combustion may also be affected.

While Nickel and Nickel alloys traditionally have been very resistant to corrosion, they have been susceptible to electrical spark erosion. To reduce electrical spark erosion, manufacturers have substituted metals or metal alloys, which are generally more resistive to spark erosion, such as Platinum, Iridium, or alloys thereof. As Platinum and Iridium are generally expensive, it is desirable to minimize the amount of material used to provide the spark portion or form the firing tip. Therefore, a spark portion or firing tip formed out of Platinum or Iridium or alloys thereof is typically attached to a Nickel or Nickel alloy center electrode to maximize efficiency of the spark plug while minimizing the amount of precious material used in the spark plug.

The use of high compression engines to improve fuel economy has required increased power passing through the spark plug to force the spark to jump the gap between the center electrode and ground electrode in a higher compression environment. This increased power has increased the rate of spark erosion in materials susceptible to spark erosion and more spark plug manufacturers are turning away from commonly used Nickel or Nickel alloy materials in search of materials that are highly resistant to spark erosion such as Platinum, Iridium, or alloys thereof. In operation, electrical pulses routinely occur up to 40,000 volts and sometimes exceeding 40,000 volts are applied through the spark plug to the center electrode, thereby causing the spark to jump the gap between the center and ground electrodes. Any increase in the operating voltage and energy of a spark plug also increases the likelihood of spark erosion and therefore reduces the longevity of the spark plug.

While Platinum, Iridium, or other precious metals and alloys thereof are less susceptible to spark erosion, if too small of a piece, either in length, width, or size is used for the precious metal firing tip, the spark may jump around the precious firing tip and arc between the base material of the center electrode and the ground electrode. As the base material is typically a Nickel alloy, it is susceptible to spark erosion which may cause the base material or center electrode to erode away until the precious metal firing tip falls off. Any degradation of the spark plug will affect the quality of the spark and any spark that does not originate from the spark surface on the spark portion but instead originates on the center electrode and passes around the precious metal firing tip will degrade the quality of the spark. The quality of the spark effects the ignition of the mixture of air and fuel (i.e., the combustion efficiency, combustion temperature, and combustion products) thus, the power output, fuel efficiency, performance of the engine, and the emissions produced by the combustion of the air and fuel mixture may be adversely affected. Due to the increasing emphasis on regulating emissions for motor vehicles, increasing fuel prices, and modern performance demands it is desirable to maintain a high quality spark for consistent engine performance and emission quality.

The longevity of the spark plug and thereby resistance of the spark plug to spark erosion is also important to engine and vehicle manufacturers. Manufacturers are increasingly requiring longer service lifetimes from spark plugs such as 160,000 km, 240,000 km, and 300,000 km service lifetimes. Many traditional Nickel spark plugs only have service lifetimes of 30,000 to 60,000 km due to spark erosion and corrosion. One method to combat spark erosion is to significantly increase the amount of precious metal material such as Iridium, Platinum, or alloys thereof forming the tip spark portion or size of the firing tip. However, Iridium, Platinum, and alloys thereof are extremely expensive and as manufacturers continually demand cost reductions, it becomes important to minimize the amount of Iridium, Platinum, or alloys thereof used in spark plugs. Therefore, a spark portion formed out of Platinum or Iridium or alloys thereof is typically attached to a Nickel or Nickel alloy center electrode and minimized in size.

Iridium is also believed to experience corrosion in the presence of Calcium and/or Phosphorus, which is enhanced at high temperatures. The increased presence of Calcium and Phosphorus in combustion materials is a relatively more recent development as engine manufacturers attempt to reduce friction to increase fuel economy by allowing more oil to seep into the combustion chamber. Calcium and Phosphorus are primarily present in engine oils and, in particular, oil additives. It is believed that Calcium and Phosphorus in the presence of oxygen during combustion within the engine cylinder react with the Iridium to form a volatile compound that evaporates and results in the loss of Iridium in the spark portion. More specifically, it is believed that gaseous Calcium during the combustion and exhaust cycle condenses on the Iridium spark portion of the spark plug and, in particular, the sides of the spark portion. It is known that molten Calcium dissolves Iridium and that Iridium is vulnerable to oxidation in the presence of Phosphorus. Therefore, the compound formed after the Phosphorus and oxygen react with the dissolved Calcium Iridium mixture is very volatile and subject to evaporation which results in loss of the Iridium spark portion. A diagram of a spark plug showing the loss of a portion of the spark portion is shown in FIG. 1. It should also be noted that Iridium may also experience some oxidation without the presence of Calcium and Phosphorus in the temperature range of about 800 to 1100° C. and with the presence of Calcium and Phosphorus the above described corrosion process may occur as low as 600° C., which is within the typical operating range of a spark plug. Of course, as engine compression increases, the temperature operating range of a spark plug will increase and oxidation of Iridium even without the presence of Calcium and Phosphorus will increasingly become a problem.

While Platinum and Platinum alloys are very good at reducing spark erosion, they may also be susceptible to corrosion. Furthermore, Platinum and Platinum alloys when used as the spark portion may form various nodule or growth features on the spark portion. Over time these growths may eventually interfere with the spark or change the spark gap or spark profile thereby reducing the performance of the spark plug. Furthermore, as some of the combustion gases may cause corrosion of the Platinum spark portion, such corrosion may cause the spark plug gap to change and thereby reduce the performance of the spark plug. Reduced performance of spark plugs can cause engine misfire, decreased fuel economy, and reduced engine performance.

The spark portion of the spark plug is typically prepared by hot rolling, hot wire drawing, or hot forming metal sheets, disks, wires, or rods. If sheets or disks are used, the minute spark portion is typically punched or pressed out and then manufactured to net shape by grinding, diamond cutting, electric discharge machining or hot heading. If wires or rods are used, the wire or rod is drawn out in an elongated shape and then cut or sheared to length and then ground, diamond cut, or hot headed to the final net shape. One problem with these manufacturing processes is that some of these materials or alloys, such as Iridium and Iridium alloys are extremely hard, extremely brittle, and have a high melting point and can difficult to efficient process to the shapes required. For example, while Platinum can be sheared, Iridium is very difficult to shear to the required shape and therefore must typically be diamond cut to the final shape. Therefore, typically in processing Iridium to form the spark portion of a spark plug, more particularly the spark portion for attachment to a center electrode on a spark plug, the manufacturing and processing costs are many times the costs of the materials even though the materials are expensive as they are generally formed from precious metals.

Therefore, there is a need for a spark portion of a spark plug which has reduced manufacturing costs and is highly resistant electrical spark erosion and corrosion mechanisms, such as Calcium and Phosphorus corrosion mechanisms, oxidation and sulfination.

### SUMMARY OF THE INVENTION

The present invention is directed to a spark plug having a center electrode with a spark portion formed from a sintered powdered metal and method of manufacture thereof. To overcome the problems in forming the spark portion of the center electrode, such as from Iridium, including forming the spark portion in various desired geometries, without waste or excessive forming costs, a method of using a sintered powdered metal to form the desired spark portion of a center electrode has been developed. Also, an Iridium alloy has been developed that allows the spark portion to be formed through a sintered powdered metal process. The alloy includes predominantly Iridium with the addition of either Copper or Nickel or more preferably the addition of both Copper and Nickel. The Iridium with Copper, or Nickel, or combination thereof both resist spark erosion as well as corrosion from Calcium and Phosphorus, oxidation, and sulfidation as well as allow the spark portion to be formed from the desired alloy through a powdered metal sintering process. Other elements such as Platinum, Palladium, Rhodium, Ruthenium, Rhenium, Chromium, Vanadium, Zirconium, Tungsten, Gold, Osmium, Iron, and Aluminum may also be used to form the spark portion, or added to the alloy to modify or enhance the desired characteristics of the spark portion.

Further scope of applicability of the present invention will become apparent from the following detailed description, claims, and drawings. However, it should be understood that the detailed description and specific examples, while indicating preferred embodiments of the invention, are given by way of illustration only, since various changes and modifications within the spirit and scope of the invention will become apparent to those skilled in the art.

### BRIEF DESCRIPTION OF THE DRAWINGS

The present invention will become more fully understood from the detailed description given here below, the appended claims, and the accompanying drawings in which:

FIG. 1 illustrates an electrode that has been corroded or eroded away;

FIG. 2 is a partial sectional view of a spark plug;

FIG. 3 is an elevational view of an electrode having a powdered metal spark portion;

FIG. 4 is an elevational view of an electrode having a powdered metal spark portion;

FIG. 5 is an elevational view of an electrode having a powdered metal spark portion;

FIG. 6 is an elevational view of an electrode having a powdered metal spark portion; and

FIG. 7 is a partial sectional view of an alternative spark plug including an alloy firing tip on both the center electrode and ground electrode.

### DETAILED DESCRIPTION OF THE PREFERRED EMBODIMENT

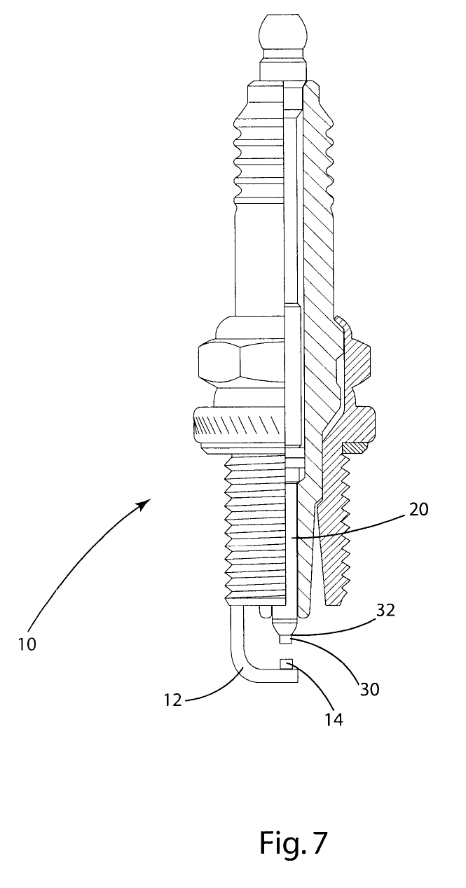

The present invention as illustrated in the figures is directed to a spark plug 10 (FIG. 2) having a ground electrode 12 and a center electrode 20. The center electrode 20 includes a spark portion 30 which is bonded, welded 32, or otherwise attached to the center electrode 20. A spark portion attached to the ground electrode is illustrated as 14 in FIG. 7 may to enhance the sparking between the ground electrode and center electrode. The spark portion 30 also includes a discharge surface 40 from which the spark passes.

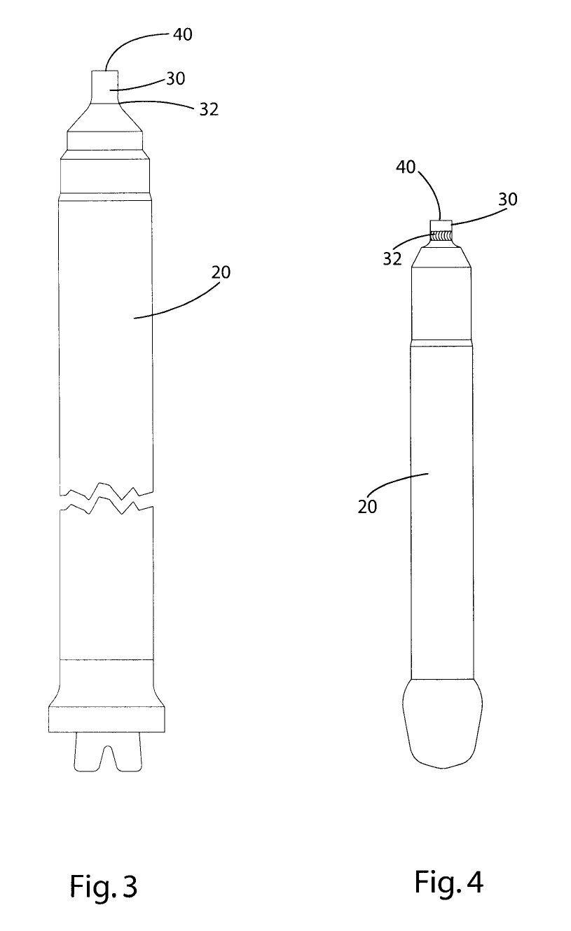

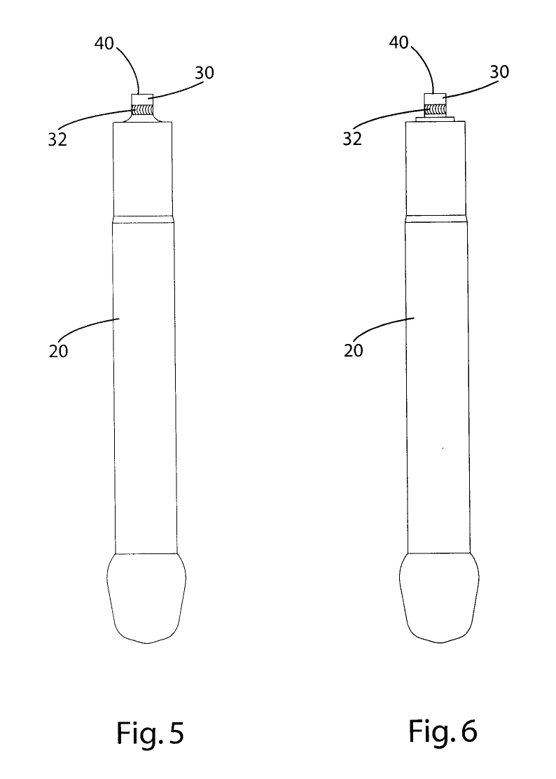

The spark portion 30 is formed from an alloy which is highly resistant spark erosion, and corrosion. The spark portion may also be formed from an Iridium alloy that is highly resistant to Calcium and Phosphorus corrosion mechanisms that typically corrode Iridium spark portions. This Iridium alloy includes Nickel (Ni) and Copper (Cu) which allows the spark portion 30 to be formed through a powdered metal sintering process which is not possible or very difficult to do with pure Iridium or common Iridium alloys. The addition of the Nickel and Copper to the Iridium allow the formation of the spark portion through the powdered metal sintering process while retaining or improving resistance to Calcium and Phosphorus corrosion and oxidation, durability against spark erosion, and sufficient longevity. Different embodiments may be seen in FIGS. 3-6 of attaching the spark portion 30 to the center electrode 20, including in FIG. 6, a multi-layer spark portion, wherein a powdered metal firing tip is attached first to a base material, such as a Nickel alloy and then further attached to the center electrode 20.

The Iridium alloy is formed from 50% to 96% Iridium by weight, 0% to 30% Nickel by weight, and 0% to 20% Copper by weight. While an Iridium-Nickel-Copper alloy is a preferred embodiment, it has also been found that Iridium-Nickel and believed that Iridium-Copper alloys may also be formed through the powdered metal sintering process while still retaining sufficient durability to spark erosion and superior resistance to combustion corrosion and in particular corrosion from Calcium, Phosphorus, Sulfur, and Oxygen. The alloy may further include elements selected from the group consisting of Platinum (Pt), Palladium (Pd), Rhodium (Rh), Ruthenium (Ru), Rhenium (Re), Chromium (Cr), Vanadium (V), Zirconium (Zr), Tungsten (W), Gold (Au), Osmium (Os), Iron (Fe), and Aluminum (Al) to further refine or enhance the desired characteristics of the alloy.

It has been found or it is believed that the following elements or alloys provide sufficient protection against corrosion, sufficient durability, and sufficient work function when added to Iridium, Platinum, or an Iridium and Platinum alloy. When used with the following elements or alloys thereof, the Iridium, Platinum, or alloys thereof form at least 50% by weight of the spark portion and therefore form the primary material of the spark portion. These elements or alloys include (1) Nickel, (2) Copper, (3) Nickel and Copper, (4) Nickel and Chromium, (5) Nickel, Copper, and Chromium, (6) Copper and Chromium, (7) Nickel plus one of the elements selected from the group consisting of Palladium, Rhodium, Ruthenium, Rhenium, Vanadium, Zirconium, Tungsten, Gold, Osmium, Iron, and Aluminum, (8) Copper plus one of the elements selected from the group consisting of Palladium, Rhodium, Ruthenium, Rhenium, Vanadium, Zirconium, Tungsten, Gold, Osmium, Iron, and Aluminum, (9) Nickel, Copper, plus one of the elements selected from the group consisting of Palladium, Rhodium, Ruthenium, Rhenium, Vanadium, Zirconium, Tungsten, Gold, Osmium, Iron, and Aluminum, (10) Nickel, Chromium, and an element selected from the group consisting of Palladium, Rhodium, Ruthenium, Rhenium, Vanadium, Zirconium, Tungsten, Gold, Osmium, Iron, and Aluminum, (11) Copper, Chromium, and an element selected from the group consisting of Palladium, Rhodium, Ruthenium, Rhenium, Vanadium, Zirconium, Tungsten, Gold, Osmium, Iron, and Aluminum, (12) Nickel, Copper, Chromium, and an element selected from the group consisting of Palladium, Rhodium, Ruthenium, Rhenium, Vanadium, Zirconium, Tungsten, Gold, Osmium, Iron, and Aluminum, (13) Nickel, Copper, Tungsten, and an element selected from the group consisting of Palladium, Rhodium, Ruthenium, Rhenium, Vanadium, Zirconium, Gold, Osmium, Iron, and Aluminum, (14) Nickel, Tungsten, and an element selected from the group consisting of Palladium, Rhodium, Ruthenium, Rhenium, Vanadium, Zirconium, Gold, Osmium, Iron, and Aluminum, (15) Copper, Tungsten, and an element selected from the group consisting of Palladium, Rhodium, Ruthenium, Rhenium, Vanadium, Zirconium, Gold, Osmium, Iron, and Aluminum, (16) Nickel, Chromium, Tungsten, and an element selected from the group consisting of Palladium, Rhodium, Ruthenium, Rhenium, Vanadium, Zirconium, Gold, Osmium, Iron, and Aluminum, (17) Copper, Chromium, Tungsten, and an element selected from the group consisting of Palladium, Rhodium, Ruthenium, Rhenium, Vanadium, Zirconium, Gold, Osmium, Iron, and Aluminum, (18) Nickel, Copper, Chromium, Zirconium, and an element selected from the group consisting of Palladium, Rhodium, Ruthenium, Rhenium, Vanadium, Tungsten, Gold, Osmium, Iron, and Aluminum, (19) Copper, Chromium, Zirconium, and an element selected from the group consisting of Palladium, Rhodium, Ruthenium, Rhenium, Vanadium, Tungsten, Gold, Osmium, Iron, and Aluminum, (20) Nickel, Chromium, Zirconium, and an element selected from the group consisting of Palladium, Rhodium, Ruthenium, Rhenium, Vanadium, Tungsten, Gold, Osmium, Iron, and Aluminum, (21) Copper, Zirconium, Tungsten, and an element selected from the group consisting of Palladium, Rhodium, Ruthenium, Rhenium, Vanadium, Gold, Osmium, Iron, and Aluminum, (22) Nickel, Zirconium, Tungsten, and an element selected from the group consisting of Palladium, Rhodium, Ruthenium, Rhenium, Vanadium, Gold, Osmium, Iron, and Aluminum, (23) Copper, Nickel, Zirconium, Tungsten, and an element selected from the group consisting of Palladium, Rhodium, Ruthenium, Rhenium, Vanadium, Gold, Osmium, Iron, and Aluminum, (24) Chromium and an element selected from the group consisting of Palladium, Rhodium, Ruthenium, Rhenium, Vanadium, Zirconium, Tungsten, Gold, Osmium, Iron, and Aluminum, (25) Chromium, Zirconium, and an element selected from the group consisting of Palladium, Rhodium, Ruthenium, Rhenium, Vanadium, Zirconium, Tungsten, Gold, Osmium, Iron, and Aluminum, (26) Chromium, Zirconium, Tungsten, and an element selected from the group consisting of Palladium, Rhodium, Ruthenium, Rhenium, Vanadium, Gold, Osmium, Iron, and Aluminum, (27) Nickel, Rhodium, plus one of the elements selected from the group consisting of Palladium, Ruthenium, Rhenium, Vanadium, Zirconium, Tungsten, Gold, Osmium, Iron, and Aluminum, (28) Copper, Rhodium, plus one of the elements selected from the group consisting of Palladium, Ruthenium, Rhenium, Vanadium, Zirconium, Tungsten, Gold, Osmium, Iron, and Aluminum, (29) Nickel, Copper, Rhodium, plus one of the elements selected from the group consisting of Palladium, Ruthenium, Rhenium, Vanadium, Zirconium, Tungsten, Gold, Osmium, Iron, and Aluminum, (30) Tungsten and Nickel, (31) Tungsten and Copper, and (32) Tungsten and Vanadium. Of course Palladium, Ruthenium, Tungsten, Rhodium, and Rhenium, or alloys thereof may be substituted for either the Iridium or Platinum, or alloys thereof as the primary material to which the above listed elements may be added.

The firing tip 30 includes at least 40% and more particularly at least 50% by weight Iridium, Platinum, Palladium, Rhodium, Ruthenium, Rhenium, Tungsten or combination thereof. Furthermore, the firing tip 30 includes less than 99%, more particularly less than approximately 98%, and typically less than approximately 95% of Iridium, Platinum, Palladium, Rhodium, Ruthenium, Rhenium, Tungsten or combination thereof. The inventors have found that a firing tip having about 80% to 98% and more particularly 85% to 98% and yet more particularly 88% to 93% by weight of Iridium, Platinum, Palladium, Rhodium, Ruthenium, Rhenium, Tungsten or combination thereof provides a firing tip with desirable characteristics.

As stated above, the firing tip includes Nickel, Copper, or Nickel and Copper. More preferably, the firing tip also includes at least one element selected from the group consisting of Chromium, Tungsten, Vanadium, or Zirconium. The addition of Copper or Chromium, at least to Iridium or Platinum, provides an alloy with substantial desirable characteristics for a firing tip, such as enhanced corrosion protection, enhanced spark erosion resistance, and enhanced sparking as compared with firing tips formed solely from either Nickel or Iridium. Exemplary alloy firing tips may include 88% to 95% Iridium, and 2% to 12% Copper; 88% to 95% Iridium and 5% to 12% Nickel; 85% to 95% Iridium, 2% to 6% Copper, and 5% to 10% Nickel; 85% to 95% Iridium, 3% to 10% Nickel, and 1% to 6% Chromium; 85% to 95% Iridium, 2% to 6% Copper, and 2% to 6% Chromium; or 85% to 95% Iridium and 2% to 10% Nickel, 2% to 6% Copper, and 1% to 6% Chromium. Other elements such as Nickel, Vanadium, Zirconium, Tungsten, Platinum, Palladium, Rhodium, Ruthenium, Rhenium, Gold (Au), Osmium (Os), Iron (Fe), and Aluminum (Al) may be added to the above Iridium-Copper, Iridium-Nickel, Iridium-Nickel-Copper, or Iridium-Nickel-Chromium, Iridium-Copper-Chromium, Iridium-Nickel-Copper-Chromium, Iridium-Tungsten, Iridium-Tungsten-Nickel, or alloys thereof to provide improved or enhanced protection to corrosion and oxidation. Of the above additional elements, it has been found that Platinum, Vanadium, Zirconium, and Tungsten, or combination thereof, are particularly advantageous to add to an lridium-Copper, Iridium-Nickel, Iridium-Copper-Nickel, Iridium-Copper-Chromium, Iridium-Nickel-Chromium, or Iridium-Nickel-Copper-Chromium alloy firing tip. In particular, up to 3% Vanadium, 3% Platinum, 3% Zirconium, and 7% Tungsten, or in some combination up to 10% by weight may be added to enhance the desirable characteristics of the alloy firing tip for the above exemplary embodiments. However, for a spark portion having at least 50% of a primarily material of Iridium, Platinum, Palladium, Rhodium, Ruthenium, Rhenium, Tungsten or combination thereof may include up to 15% Vanadium, 50% Platinum (when the primary material is not Platinum), 10% Zirconium, and 50% Tungsten, or in some combination up to 50% by weight of the spark portion.

As stated above, the firing tip 30 may include Nickel, Copper, or Nickel and Copper. It has been found that adding Nickel up to 50% by weight may add desirable characteristics, before the susceptibility of Nickel to electrical spark erosion overcomes the benefits of Nickel against corrosion. It has been found that the addition of Nickel to the firing tip 30 to form an alloy containing at least 50% by weight of Iridium and 0.5% to 50% Nickel with the addition of an element selected from the group consisting of Copper, Chromium, Vanadium, Zirconium, and Tungsten provides excellent wear resistance, longevity, and resistance to erosion and corrosion. It has been further found that the addition of Nickel to Iridium in an amount of 4% to 40% by weight provides excellent resistance to erosion and corrosion and increases the longevity and wear resistance of the firing tip. Another addition to the above Iridium Nickel spark portion is Platinum.

When Nickel is added in an amount of 0.5% to 40% by weight to an Iridium-Copper firing tip, which includes at least one element selected from the group consisting of Chromium, Vanadium, Zirconium, and Tungsten, the alloy forming the firing tip 30 has increased longevity and wear resistance as well as resistance to erosion and corrosion. More specifically it has been found that a firing tip having at least 50% Iridium, up to 20% by weight Chromium, and a substantial portion of the balance being Nickel provides an excellent balance of desirable characteristics. It has also been found that a firing tip having up to 20% by weight Copper, at least 50% by weight Iridium and a substantial portion of the balance being Nickel provides an excellent balance of desirable characteristics. Another alloy with an excellent balance of desirable characteristics includes at least 50% Iridium, either Copper, Chromium or combination of at Copper and Chromium up to 40% by weight and the substantial portion of the balance being Nickel. In all of the above alloys, the alloy contains at least 0.5% and more particularly at least 1% of either Copper, Chromium, or the combination of Copper and Chromium. Of course, the alloy may be further improved by the addition of Platinum, Palladium, Rhodium, Ruthenium, Rhenium, Vanadium, Zirconium, and Tungsten individually or combinations thereof to improve the longevity and improve the wear resistance as well as stop erosion and corrosion that happens to pure Iridium or pure Nickel firing tips when used in spark plugs.

In particular it has been found that spark plugs containing 40% to 95% Iridium by weight, 4% to 40% Nickel by weight, 0% to 20% Copper by weight, and 0% to 20% Chromium by weight wherein either said Copper or Chromium or Copper and Chromium combined form 0.5% to 40% by weight, provides excellent wear resistance, increased longevity and excellent resistance to erosion and corrosion. While the reason is unknown, the addition of either Copper or Chromium or the combination of Copper and Chromium with Nickel and Iridium provides the desired benefits and improves the desired characteristics, compared to a firing tip for a spark plug that includes only Iridium or only Nickel. The addition of the other elements such as Platinum, Palladium, Rhodium, Ruthenium, Rhenium, Vanadium, Zirconium, and Tungsten also can help improve the alloy characteristics.

While the Iridium Nickel Copper alloy can contain 50% to 93% Iridium, 0% to 30% Nickel, and 0% to 20% Copper by weight, and still provide the desired characteristics it has been found that a composition formed from approximately 88% to 91% Iridium, 6% to 7.5% Nickel, and 2.5% to 4.5% Copper by weight provides the best overall combination of desired characteristics, including (1) the good durability to spark erosion, (2) good resistance to, Phosphorus, Oxygen, Sulfur, and Calcium corrosion, and (3) easy formation through a powdered metal sintering process.

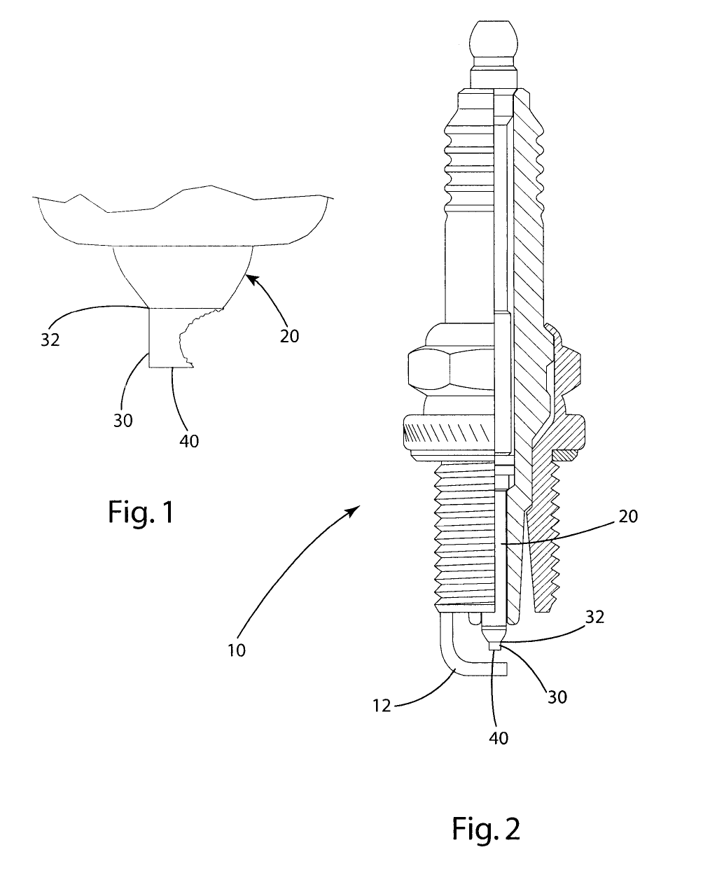

The spark plug and particularly the spark portion of the spark plug is formed through a powdered metal sintering process which allows powdered metal of each element of the alloy to be mixed thoroughly and then formed to net shape by sintering the powdered metal in molds at high temperature and pressure. The addition of the Nickel or Copper or combination thereof allows the formation at lower temperatures and pressures than previously possible with Iridium or common Iridium alloys. The powdered metal sintering process is similar to those commonly used for manufacturing many other items with powdered metal. Previously, due to the extreme pressure and temperature required to form powdered Iridium metal to the final net shape, it was impractical or impossible to use this process to manufacture the spark portion 30 of the spark plug. However, the addition of Nickel or Copper or in particular the combination of Nickel and Copper thereof to Iridium to form an alloy with the given percent ranges described above allows for easy powdered metal sintering process and removes the need for additional steps to form the spark portion 30 to net shape such as grinding, diamond cutting, or hot heading. Furthermore, the addition of Nickel or Copper or both Nickel and Copper provides increased resistance to in particular Calcium and Phosphorus corrosion to prevent the spark portion looking like the picture in FIG. 1. Furthermore, the addition of Nickel or Copper also reduces the brittleness and the susceptibility of the spark portion 30 from being damaged during the manufacturing process allowing easier manufacturing.

The foregoing discussion discloses and describes an exemplary embodiment of the present invention. One skilled in the art will readily recognize from such discussion, and from the accompanying drawings and claims that various changes, modifications and variations can be made therein without departing from the true spirit and fair scope of the invention as defined by the following claims.

What is claimed is:

1. A spark plug having a center electrode and a ground electrode and wherein at least one of said center electrode and said ground electrode comprise:
a spark portion formed from powder metal and including at least 50% by weight Iridium and including at least one element selected from the group consisting of Copper, Chromium, Vanadium, Zirconium, Tungsten, Osmium, Gold, Iron, Aluminum, Nickel, Ruthenium, Rhenium, Rhodium, Palladium, and Platinum.

2. The spark plug of claim 1 wherein said spark portion includes less than 30% by weight Nickel.

3. The spark plug of claim 1 wherein said spark portion includes less than 30% by weight Copper.

4. The spark plug of claim 1 wherein said spark portion includes 50-96% by weight Iridium.

5. The spark plug of claim 4 wherein said spark portion includes 0-30% Nickel and 0-30% Copper by weight.

6. The spark plug of claim 5 wherein said spark portion includes 1-10% Nickel and 1-10% Copper by weight.

7. The spark plug of claim 6 wherein said spark portion includes 4-8% Nickel and 1-6% Copper by weight.

8. The spark plug of claim 7 wherein said spark portion includes 5-8% Nickel and 2-5% Copper by weight.

9. The spark plug of claim 8 wherein said spark portion includes 6-7.5% by weight Nickel.

10. The spark plug of claim 8 wherein said spark portion includes at 2.5-4.5% by weight Copper.

11. The spark plug of claim 8 wherein said spark portion includes 80-96% Iridium by weight.

12. The spark plug of claim 8 wherein said spark portion includes 85-96% by weight Iridium.

13. The spark plug of claim 8 wherein said spark portion includes 88-91% Iridium by weight.

14. The spark plug of claim 9 wherein said spark portion includes 88-91% Iridium by weight.

15. The spark plug of claim 10 wherein said spark portion includes 88-91% Iridium by weight.

16. The spark plug of claim 1 formed through a powered metal sintering process.

17. The spark plug of claim 8 formed through a powdered metal sintering process.

18. The spark plug of claim 9 formed through a powdered metal sintering process.

19. The spark plug of claim 10 formed through a powdered metal sintering process.

20. A spark plug having a center electrode and a ground electrode and wherein at least one of said center electrode and said ground electrode comprise:
a spark portion formed from a sintered powdered metal, said powdered metal including at least one element selected from the group consisting of Iridium, Copper, Chromium, Vanadium, Zirconium, Tungsten, Osmium, Gold, Iron, Aluminum, Nickel, Ruthenium, Rhenium, Rhodium, Palladium, and Platinum.

21. The spark plug of claim 20 wherein said spark portion includes a second element selected from the group consisting of Iridium, Copper, Chromium, Vanadium, Zirconium, Tungsten, Osmium, Gold, Iron, Aluminum, Nickel, Ruthenium, Rhenium, Rhodium, Palladium, and Platinum, and wherein said second element is different from said at least one element selected from the group consisting of Iridium, Copper, Chromium, Vanadium, Zirconium, Tungsten, Osmium, Gold, Iron, Aluminum, Nickel, Ruthenium, Rhenium, Rhodium, Palladium, and Platinum.

22. The spark plug of claim 21 wherein said spark portion includes a third element selected from the group consisting of Iridium, Copper, Chromium, Vanadium, Zirconium, Tungsten, Osmium, Gold, Iron, Aluminum, Nickel, Ruthenium, Rhenium, Rhodium, Palladium, and Platinum and wherein said first element is different from said second element and said at least one element selected from the group consisting of Iridium, Copper, Chromium, Vanadium, Zirconium, Tungsten, Osmium, Gold, Iron, Aluminum, Nickel, Ruthenium, Rhenium, Rhodium, Palladium, and Platinum.

23. The spark plug of claim 20 a spark portion formed from a sintered powdered metal, said powdered metal including at least one element selected from the group consisting of Iridium, Copper, Chromium, Vanadium, Zirconium, Tungsten, Osmium, Gold, Iron, Aluminum, Nickel, Ruthenium, Rhenium, Rhodium, Palladium, and Platinum, is selected from a group consisting of Iridium, Copper, Chromium, Zirconium, Tungsten, Nickel, Ruthenium, Rhenium, Rhodium, Palladium, and Platinum and includes a second element selected from the group consisting of Iridium, Copper, Chromium, Zirconium, Tungsten, Nickel, Ruthenium, Rhenium, Rhodium, Palladium, and Platinum, wherein said second element is different than said at least one element.

24. The spark plug of claim 20 wherein said at least one element is Platinum, Iridium or Tungsten, said at least one element forming the majority by weight of the spark portion.

25. The spark plug of claim 24 further including at least one element selected from the group consisting of Copper, Chromium and Nickel.

26. A spark plug having a center electrode and a ground electrode and wherein at least one of said center electrode and said ground electrode comprise:
a spark portion formed from a sintered powdered metal, said powdered metal including at least 50% Iridium, Platinum, Tungsten, Rhenium, Rhodium, Palladium, approximately 0% to 30% Nickel, 0% to 20% Copper by weight, and 0% to 30% Chromium and wherein said powdered metal includes at least 1% of an element selected from the group consisting of Nickel, Copper and Chromium.

27. The spark plug of claim 26 wherein said powdered metal includes 50% to 93% Iridium, 0% to 30% Nickel, and 0% to 20% Copper by weight.

28. The spark plug of claim 26 wherein said powdered metal includes approximately 88% to 93% Iridium, 6% to 7.5% Nickel, and 2.5% to 4.5% Copper.

29. The spark plug of claim 26 wherein said powdered metal includes approximately 6% to 7.5% Nickel, and 2.5% to 4.5% Copper.
